(19) United States
(12) Patent Application Publication
(10) Pub. No.: US 2007/0119082 A1
(43) Pub. Date: May 31, 2007

(54) Extensible Folder Tab

(76) Inventor: Wayde Gilchrist, Frisco, TX (US)

Correspondence Address: WAYDE GILCHRIST, 4482 LIAM DR., FRISCO, TX, 75034, US

(21) Appl. No.: 11/164,611

(22) Filed: Nov. 30, 2005

(51) Int. Cl. G09F 23/10

(52) U.S. Cl. 40/641

(57) ABSTRACT

An extensible folder tab design for providing a means to elevate the index tab of a currently active folder in a file cabinet, cart, or other filing system. The inventive device includes a fixed base and a movable title portion. The fixed base portion attaches to a file folder. The movable piece, inserted into a cutout in the fixed base, slides freely within the fixed portion. The movable title portion includes a means to support a title card or other label.

### BACKGROUND OF THE INVENTION

The present invention relates generally to file folder tabs and more specifically it relates to an extensible folder tab for providing a means to elevate the index tab of a currently active folder in a file cabinet, cart, or other filing system that utilizes file folders. When working with files in folders, it is often necessary to locate the same folder repeatedly. One example is when a document has been removed from the folder and will need to be returned to the same location shortly. It can be an unnecessarily cumbersome task to locate the same folder among the numerous others. By raising the index tab, an active folder can be quickly located.

It can be appreciated that file folder tabs have been in use for years. Typically, file folder tabs are comprised of plastic tabs with paper title card inserts that attach onto or insert into hanging folders.

The main problem with conventional file folder tabs is that folder tabs in a file drawer or other file storage unit all stand at the same visual height. This makes it difficult to relocate a currently active folder repeatedly. Folder tabs such as those described in U.S. Pat. Nos. 6,332,285, 5,953,843, and 5,311,685 provide means to support an index title and attachment to hanging folders of various types. However, these and other prior art folder tabs do not provide means for vertical movement of the title card to allow currently active folders to be quickly located.

In this respect, the extensible folder tab according to the present invention substantially departs from the conventional concepts and designs of the prior art.

### SUMMARY

In view of the foregoing disadvantages inherent in the known types of file folder tab now present in the prior art, the present invention provides a new extensible folder tab construction wherein the same can be utilized for providing a means to elevate the index tab of a currently active folder in a file cabinet, cart, or other filing system.

The general purpose of the present invention, which will be described subsequently in greater detail, is to provide a new extensible folder tab that has many of the advantages of the file folder tabs mentioned heretofore and many novel features that result in a new extensible folder tab which is not anticipated, rendered obvious, suggested, or even implied by any of the prior art file folder tab, either alone or in any combination thereof.

To attain this, the present invention generally comprises a fixed base portion and a movable title portion. The fixed base portion attaches to a file folder similar to prior art index tab designs. The movable piece, inserted through a cutout in the fixed base, slides freely within the fixed portion. The movable title portion includes a means to support a title card or other label. The fixed base portion is an elongate structure having means to attach near the top edge of a hanging folder. It includes an opening along the top elongated portion and an opening along the bottom elongated portion.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an extensible folder tab that will overcome the shortcomings of the prior art devices.

An object of the present invention is to provide an extensible folder tab for providing a means to elevate the index tab of a currently active folder in a file cabinet, cart, or other filing system. When working with a file system, it is often necessary to locate the same folder repeatedly. One example is when a document has been removed from a folder and will need to be returned to the same location shortly. It can be an unnecessarily cumbersome task to locate the same folder among the numerous others. By raising the index tab, an active folder can be quickly located.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front view of the invention mounted in a standard hanging file folder.

FIG. 2 is a perspective view of the fixed base portion of the invention.

FIG. 3 shows fixed base portion unfolded.

FIG. 4 is a perspective view of the movable title portion.

FIG. 5 shows the movable title portion unfolded.

FIG. 6 is a perspective view of the movable title portion inserted into the cutout of the fixed base portion.

FIG. 7 is a perspective view of the fixed base portion with optional crimps.

### DETAILED DESCRIPTION

Turning now descriptively to the drawings, in which similar reference characters denote similar elements throughout the several views, the attached figures illustrate an extensible folder tab, which comprises a fixed base portion and a movable title portion.

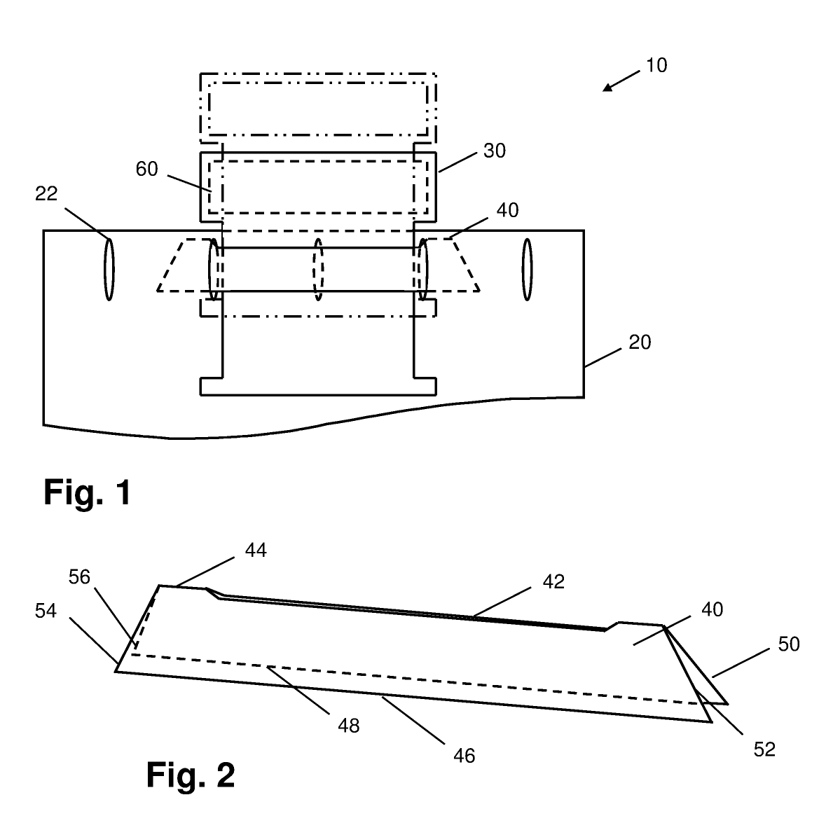

FIG. 1 shows extensible folder tab 10 of this invention. The ends of the fixed base portion 40 insert into folder slots 22 of hanging folder 20. The movable title portion 30, inserted through a cutout in the fixed base 40, is able to slide within the fixed portion. Two positions of the movable title 30 are shown in FIG. 1. The movable title portion 30 includes a means to support a title card 60 or other label.

As shown in FIG. 2 of the drawings, the fixed base 40 is preferably a folded elongate and flat structure having an upper edge 44, lower edges 46 and 48, and tapered ends 50, 52, 54 and 56. The tapered ends 50, 52, 54 and 56 are shaped to fit into openings 22 in hanging folder 20 as shown in FIG. 1.

The fixed base 40 may be constructed of a folded single sheet of thin material with a cutout 42 as shown in FIG. 3. The fixed base 40 may be constructed of various materials such as plastic, cardboard, metal or other well-known material. The chosen material should be sufficiently rigid to resist bending, but pliable enough to be folded as shown in FIG. 2. Fixed base 40 may be alternatively shaped to attach to various hanging folder designs.

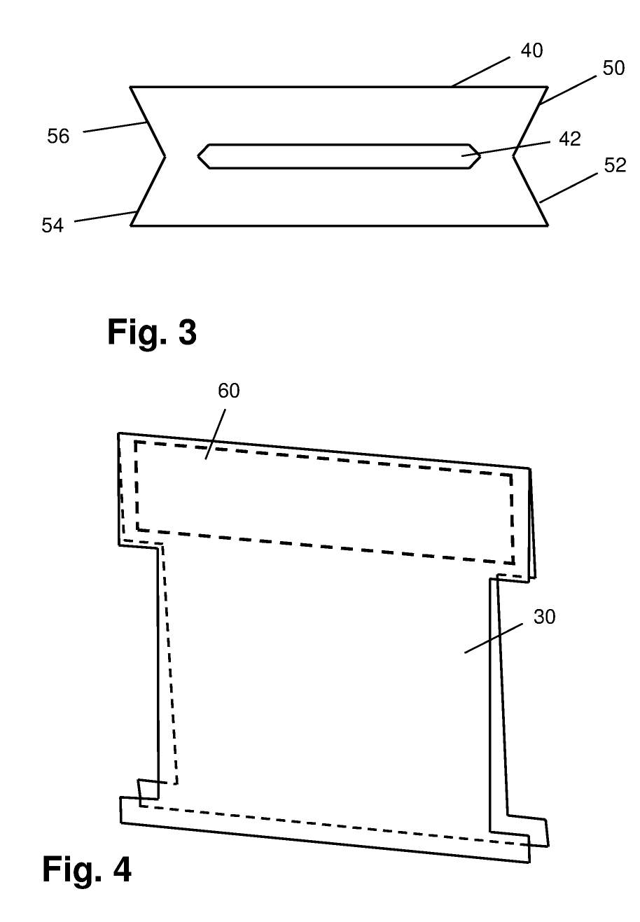

The movable title portion 30 is shown in FIG. 4. Similar to existing index tabs, a title card 60 may be inserted between the two sides of the folded title portion 30. The fold on the top of the title portion may be of large radius to provide a ridge for easy gripping.

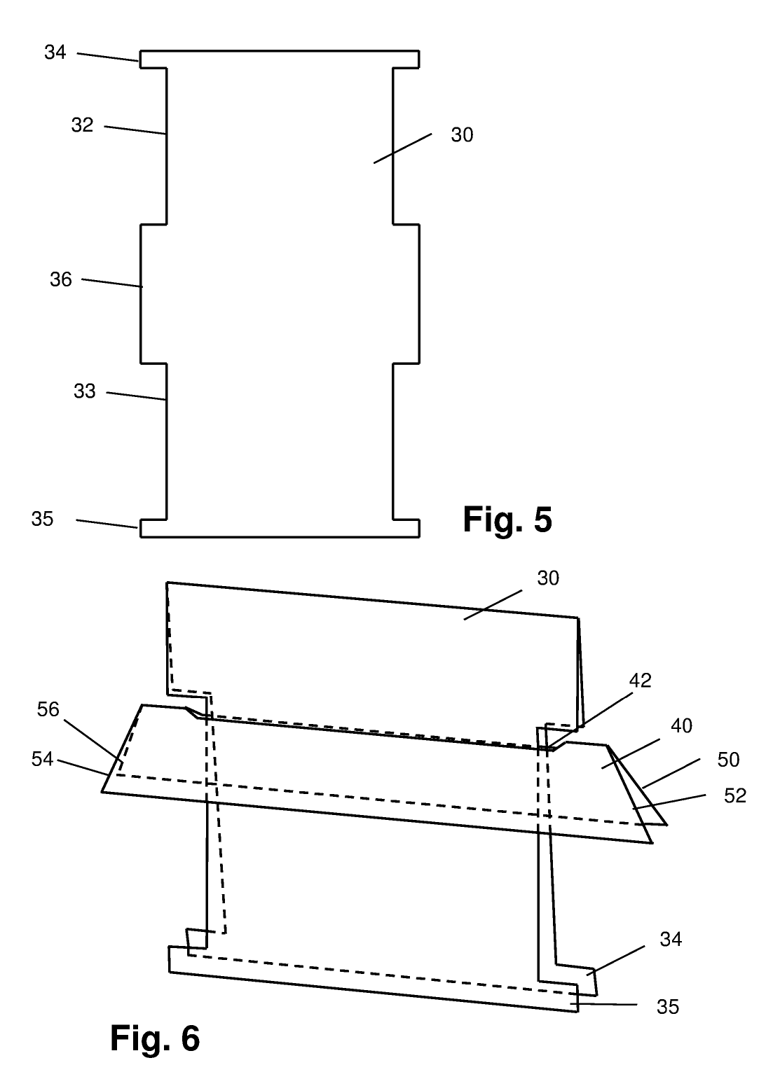

As shown in FIG. 5 of the drawings, the moveable title 30 is a flat structure having a title card area 36, narrow middle portions 32 and 33, and vertical stops 34 and 35. Movable title 30 is preferably constructed from the same material as the fixed base 40. The vertical stops 34 and 35 of movable title 30 extend to a width greater than the separation of the hanging folder openings. The width of middle portions 32 and 33 is less than the separation of the hanging folder openings.

FIG. 6 shows the folder tab assembly comprised of folded movable title portion 30 inserted through the cutout 42 in folded fixed base 40 and extending out the bottom. The width of the bottom portion of fixed base 40, including the vertical stops 34 and 35, may be greater than the width of the cutout 42 in fixed base 40. Therefore, to insert the movable title portion 30 through opening 42, the movable title portion will need to be tilted relative to the fixed base 40, first inserting one corner, and then the remaining bottom area of movable title 30.

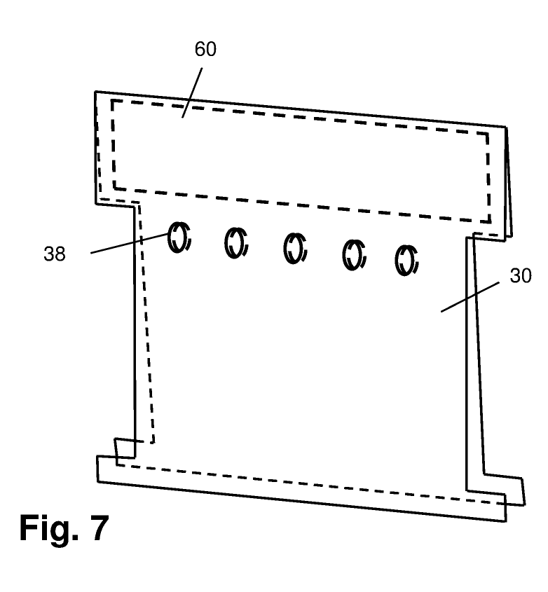

For additional support of title card 60, the movable title 40 may be crimped or otherwise indented in one or more locations below the title card area. FIG. 7 shows one possible orientation of crimps 38.

Operation

Similar to existing index tabs, a title card 60 may be inserted between the two sides of the folded title portion 30. Alternately, title card 60 may be attached to the outside of the tab using adhesive, tape, or other form of adhesion. The folder tab assembly shown in FIG. 6 is attached to a hanging folder 20 by inserting the tapered ends 50, 52, 54 and 56 into two of the hanging folder openings 22 as shown in FIG. 1.

The movable title component 30 slides through the cutout 42 of fixed base 40. Two positions of movable title 30 are illustrated in FIG. 1. To operate the folder tab, the user raises movable title 30 through fixed base 40 to a desired height or until the vertical stops 34 and 35 contact the lower edges 46 and 48 of fixed base 40. After the user releases the tab, the movable title 30 remains in the raised position due to the friction fit of movable title 30 in fixed base 40. The user lowers the movable title 30 through fixed base 40 by pushing it down to a desired height or until title card area 36 contacts the top edge of hanging folder 20.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The fixed base 40 may be modified in numerous ways to attach to various forms of current and future hanging folders or other file folders. The fixed base 40 and movable title 30 of this embodiment are adaptations of one existing immovable folder tab design. Other folder tab designs may be adapted similarly.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A folder tab, comprising:
a. a fixed base portion,
b. a movable title portion,
c. means for loosely coupling said movable title portion to said fixed base portion, and
d. means for attaching said fixed base portion to a file folder,
whereby a user may raise and lower said movable title portion relative to said fixed base portion and said file folder.

2. The folder tab of claim 1 wherein said fixed base portion is an elongate and flat structure with tapered ends.

3. The folder tab of claim 2 wherein said means for attaching said fixed base portion to said file folder comprises sliding said tapered ends into openings of said file folder.

4. The folder tab of claim 1 wherein said fixed base portion is composed of folded flat material.

5. The folder tab of claim 4 wherein said means for coupling said movable title portion to said fixed base portion comprises the insertion of said movable title portion into a cutout in said fixed base portion.

6. The folder tab of claim 1 wherein said movable title portion is composed of folded flat material.

7. The folder tab of claim 6 wherein said folded flat material is transparent, whereby a title card inserted between the halves of said movable title portion is visible through said transparent material.

8. The folder tab of claim 7 wherein said movable title portion is indented to secure said title card.

9. A method of raising a folder tab relative to a file folder, comprising:
a. providing an elongate fixed base portion comprising a flat body of folded material with tapered ends and a cutout along the fold,
b. mounting said fixed base portion to said file folder by inserting said tapered ends into openings of said file folder,
c. providing a movable title portion comprising a flat body of folded transparent material, and
d. inserting said movable title portion through said cutout in said fixed base portion, whereby said movable title portion may be raised and lowered relative to said file folder.
